(19) United States
(12) Patent Application Publication
(10) Pub. No.: US 2011/0111143 A1
(43) Pub. Date: May 12, 2011

(54) ABRASION RESISTANT MEDIA

(76) Inventors: Qi Sun, Kanagawa (JP); Yoshitaka Sugimoto, Kanagawa (JP)

(21) Appl. No.: 12/812,880

(22) PCT Filed: Oct. 27, 2008
(86) PCT No.: PCT/US08/12179

§ 371 Date: Jan. 10, 2011

Related U.S. Application Data
(60) Provisional application No. 61/005,277, filed on Dec. 4, 2007.
(60) Provisional application No. 61/011,021, filed on Jan. 14, 2008.

(51) Int. Cl. B41M 5/50; C08K 7/22

(52) U.S. Cl. 428/32.34; 523/218

(57) ABSTRACT

Abrasion resistant media, compositions used to make such media, and methods of using the media are disclosed.

### FIELD OF THE INVENTION

The present invention is directed to abrasion resistant media, compositions used to make such media, and methods of using the media.

### BACKGROUND OF THE INVENTION

There is a need in the ink jet media market for abrasion resistant media having a high pore volume, and ink adsorption while maintaining other desirable properties, such as optical density, gloss, transparency, distinctness of image, etc. There is also a need in the art for compositions use in making the abrasion resistant media.

### SUMMARY OF THE INVENTION

The present invention addresses some of the difficulties and problems discussed above by the discovery of new media coating formulation and media prepared therefrom. The composition includes two differently shaped metal oxide particles, one having an asymmetrical shape and the other having a symmetrical shape.

In one exemplary embodiment, abrasion resistant ink receiving media of the present invention comprises a substrate; and an ink receiving layer on the substrate comprising porous metal oxide particles and non-porous metal oxide particles; wherein the ink receiving layer possesses an abrasion resistance greater than, and a pore volume equal to or greater than, an ink receiving layer formed without said non-porous particles. One of the particles may be asymmetrical and the other substantially symmetrical. The particles may be of different chemical compositions and different physical structures.

In a further exemplary embodiment, abrasion resistant ink receiving media of the present invention comprises a substrate; and an ink receiving layer on the substrate comprising porous alumina particles and non-porous metal oxide particles; wherein the ink receiving layer possesses an abrasion resistance greater than, and a pore volume equal to or greater than, an ink receiving layer formed without said non-porous particles. In an exemplary embodiment, the ink receiving layer possesses Hg porosity (measured using ASTM UOP578-02) of greater than or equal to about 0.25 cc/g pore volume in unit coating weight at 30-35 g/m², which is about 1-10% higher than alumina based ink receiving layers without non-porous particles. One of the particles may be asymmetrical and the other substantially symmetrical. The particles may be of different chemical compositions and different physical structures.

In another exemplary embodiment, the abrasion resistant ink receiving media of the present invention comprises a substrate; an ink receiving layer on the substrate comprising porous metal oxide particles and non-porous metal oxide particles; and a printed pigmented ink layer on the ink receiving layer; wherein the ink receiving layer possesses a rub off resistance greater than an ink receiving layer formed without said non-porous particles.

In a further exemplary embodiment, the abrasion resistant ink receiving media of the present invention comprises a substrate; an ink receiving layer on the substrate comprising porous metal oxide particles and non-porous metal oxide particles; wherein the ink receiving layer possesses an ink adsorption speed greater than an ink receiving layer formed without said non-porous particles.

In another exemplary embodiment, an ink receiving media formulation of the present invention comprises a binder; porous metal oxide particles and non-porous metal oxide particles; wherein an ink receiving layer formed from said formulation possesses an abrasion resistance greater than, and a pore volume equal to or greater than, an ink receiving layer formed without said non-porous particles. The porous particles may be asymmetrical and the non-porous particles may be symmetrical. The particles may be of different chemical compositions and different physical structures.

An exemplary method of making an ink receiving media formulation according to the present invention comprises, forming a coated substrate including the steps of providing a substrate having a first surface; coating the formulation onto the first surface of the substrate; and drying the coated substrate. The resulting coated substrate is particularly useful as a printable substrate for color-containing compositions such as ink compositions.

In another exemplary embodiment, an ink receiving media dispersion of the present invention comprises a solvent; porous metal oxide particles and non-porous metal oxide particles; wherein an ink receiving layer formed from said dispersion possesses an abrasion resistance greater than, and a pore volume equal to or greater than, an ink receiving layer formed without said non-porous particles. The particles may be of different chemical compositions and different physical structures.

The present invention is further directed to methods of forming the exemplary ink receiving dispersions. One exemplary method comprises forming a dispersion of metal oxide particles in water including the steps of adding up to 40 wt % metal oxide particles to water, wherein the weight percent is based on a total weight of the dispersion; adding an acid to the dispersion in order to decrease the pH of the dispersion to less than about 5.0, typically less than or equal to about 4.0. The resulting dispersion desirably has a viscosity of less than about 100 cps, desirably less than about 80 cps.

These and other features and advantages of the present invention will become apparent after a review of the following detailed description of the disclosed embodiments and the appended claims.

### BRIEF DESCRIPTION OF THE FIGURES

FIG. 1 depicts a cross-sectional view of the exemplary article of the present invention, wherein the exemplary article comprises at least one layer containing metal oxide particles;

FIG. 2 depicts a scanning electron micrograph of the ink receiving layer of the present invention;

FIG. 3 depicts a transmission electron micrograph (TEM) of an asymmetrical particle according to the present invention;

FIG. 4 depicts a cross-sectional view of conventional media, wherein the printed media comprises multiple layers of pigmented ink on the surface thereof; and

FIG. 5 depicts a cross-sectional view of the exemplary article of the present invention, wherein the exemplary article comprises at least one layer containing metal oxide particles and wherein printed pigmented ink penetrates the surface into interparticle pores.

### DETAILED DESCRIPTION OF THE INVENTION

To promote an understanding of the principles of the present invention, descriptions of specific embodiments of the invention follow and specific language is used to describe the specific embodiments. It will nevertheless be understood that no limitation of the scope of the invention is intended by the use of specific language. Alterations, further modifications, and such further applications of the principles of the present invention discussed are contemplated as would normally occur to one ordinarily skilled in the art to which the invention pertains.

It must be noted that as used herein and in the appended claims, the singular forms “a”, “and”, and “the” include plural referents unless the context clearly dictates otherwise. Thus, for example, reference to “an oxide” includes a plurality of such oxides and reference to “oxide” includes reference to one or more oxides and equivalents thereof known to those skilled in the art, and so forth.

“About” modifying, for example, the quantity of an ingredient in a composition, concentrations, volumes, process temperatures, process times, recoveries or yields, flow rates, and like values, and ranges thereof, employed in describing the embodiments of the disclosure, refers to variation in the numerical quantity that can occur, for example, through typical measuring and handling procedures; through inadvertent error in these procedures; through differences in the ingredients used to carry out the methods; and like proximate considerations. The term “about” also encompasses amounts that differ due to aging of a formulation with a particular initial concentration or mixture, and amounts that differ due to mixing or processing a formulation with a particular initial concentration or mixture. Whether modified by the term “about” the claims appended hereto include equivalents to these quantities.

As used herein the term “porous” means metal oxide particles having significant porosity, i.e., a porosity of more than about 0.6 cc/g, and the term “non-porous” means metal oxide particles having little or no porosity, i.e., a porosity of less than about 0.05 cc/g. Examples of porous particles include beohmite alumina, silica gel and precipitated silica, and examples of non-porous particles include colloidal silica.

The present invention is directed to ink receiving media and formulations and dispersions suitable for making ink receiving media. The present invention is further directed to methods of making ink receiving media, as well as methods of ink receiving. A description of exemplary ink receiving media, formulations and dispersions for making ink receiving media, and methods of making ink receiving media, formulations and dispersions is provided below.

The ink receiving media of the present invention have a physical structure and properties that enable the media to provide one or more advantages when compared to known ink receiving media.

In one exemplary embodiment, an ink receiving media dispersion comprises a solvent; porous metal oxide particles and non-porous metal oxide particles; wherein an ink receiving layer formed from said dispersion possesses an abrasion resistance greater than, and a pore volume substantially equal to or greater than, an ink receiving layer formed without said non-porous particles. As used in this context, the term “substantially” means within about 1 to about 10% of the total pore volume of the ink receiving layer. The particles may be differently shaped with the porous particle being asymmetrical. A second particle may be symmetrical or asymmetrical as long as it provides the desired bonding effect in the coating without reducing the porosity of the resulting ink receiving layer.

As used herein, “asymmetrical” with respect to particle geometries is defined as those particles that possess aspect ratios of greater than 1. As used herein, the term “aspect ratio” is used to describe the ratio between (i) the average largest particle dimension of the particles and (ii) the average largest cross-sectional particle dimension of the particles, wherein the cross-sectional particle dimension is substantially perpendicular to the largest particle dimension of the particle.

Asymmetrical particles of the present invention typically have an aspect ratio of at least about 1.1 as measured, for example, using Transmission Electron Microscopy (TEM) techniques. In some embodiments of the present invention, the asymmetrical particles have an aspect ratio of at least about 1.1 (or at least about 1.2, or at least about 1.3, or at least about 1.4, or at least about 1.5, or at least about 1.6). Typically, the asymmetrical particles have an aspect ratio of from about 1.1 to about 12, more typically, from about 1.1 to about 3.0.

The particles may be of the same or different chemical compositions and may be of the same or different physical structures. The particles may be composed of metal oxides, sulfides, hydroxides, carbonates, aluminosilicates, silicates, phosphates, etc, but are preferably metal oxides. As used herein, “metal oxides” is defined as binary oxygen compounds where the metal is the cation and the oxide is the anion. The metals may also include metalloids. Metals include those elements on the left of the diagonal line drawn from boron to polonium on the periodic table. Metalloids or semi-metals include those elements that are on this line. Examples of metal oxides include silica, alumina, titania, zirconia, etc., and mixtures thereof. The particles may be of the same or different physical form or structure. For example, the particles may be amorphous or crystalline, in dry or liquid form, and may be fumed, colloidal, precipitated, gel, and so on. Preferably, the metal oxide particles comprise a first particle that is crystalline and a second particle that is amorphous, such as, for example, a first particle that is boehmitic alumina and a second particle that is colloidal silica.

Porous metal oxide particles in this embodiment of the present invention typically have an aspect ratio of at least about 1.1 as measured, for example, using Transmission Electron Microscopy (TEM) techniques. The smallest dimension of the particle, the third side of the lath may range from about 3 nm to about 15 nm, typically from about 5 nm to about 12 nm, and more typically from about 6 nm to about 10 nm. In some embodiments of the present invention, the alumina particles have an aspect ratio of at least about 1.1 (or at least about 1.2, or at least about 1.3, or at least about 1.4, or at least about 1.5, or at least about 1.6). Typically, the alumina particles have an aspect ratio of from about 1.1 to about 12, more typically, from about 1.1 to about 3.0.

Porous particles of the present invention also have a surface area as measured by the BET method (i.e., the Brunauer Emmet Teller method) of at least about 120 m²/g. In one exemplary embodiment of the present invention, the porous particles have a BET surface area of from about 150 m²/g to about 190 m²/g. In a further exemplary embodiment of the present invention, the porous particles have a BET surface area of about 172 m²/g.

Porous metal oxide particles of the present invention also have a pore volume that makes the particles desirable components in compositions such as coating compositions. Typically, the porous particles have a pore volume as measured by nitrogen porosimetry of at least about 0.40 cc/g, and more typically, 0.60 cc/g. In one exemplary embodiment of the present invention, the porous particles have a pore volume as measured by nitrogen porosimetry of at least about 0.70 cc/g. Desirably, the porous particles have a pore volume as measured by nitrogen porosimetry of from about 0.70 to about 0.85 cc/g.

Pore volume and surface area may be measured using, for example, an Autosorb 6-B unit commercially available from Quantachrome Instruments (Boynton Beach, Fla.). Typically, the pore volume and surface area of porous powder is measured after drying at about 150° C., and degassing for about 3 hours at 150° C. under vacuum (e.g., 50 millitorr).

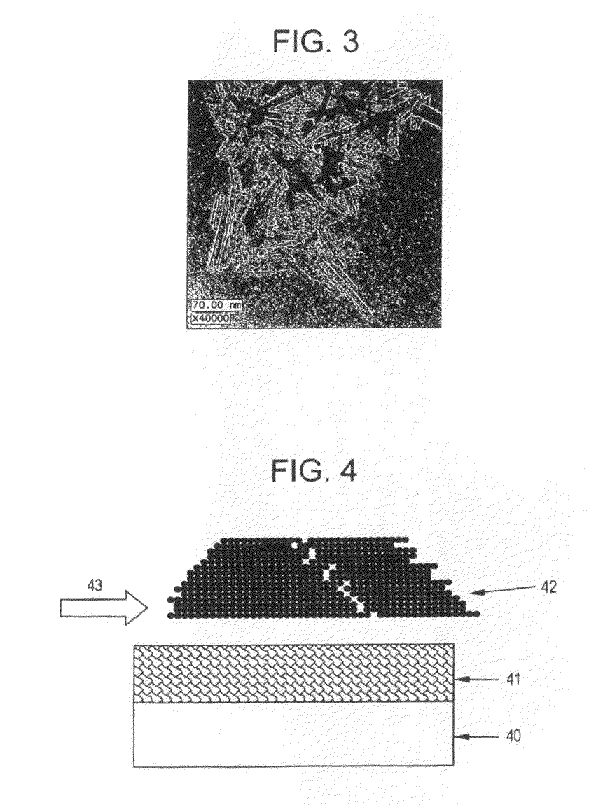

Even though any porous metal oxide particles may be utilized in the present invention, in an exemplary embodiment, the porous particles are comprised of boehmitic alumina, such as those described in U.S. Provisional patent application Ser. No. 60/749,380. The alumina particles possess an asymmetric particle shape, unlike known alumina particles having a spherical particle shape. The asymmetric particle shape is typically an elongated particle shape having an average largest particle dimension (i.e., a length dimension) that is greater than any other particle dimension (e.g., a cross-sectional dimension substantially perpendicular to the average largest particle dimension) and is preferably in a lath shape. As defined herein “lath” means a shape whose cross-section is rectangular in nature, which may be differentiated with a rod-like or acicular shape that has a symmetrical cross-section. The smallest dimension of the particle, the third side of the lath may range from about 3 nm to about 15 nm, typically from about 5 nm to about 12 nm, and more typically from about 6 nm to about 10 nm. Typically, the alumina particles of the present invention have an average largest particle dimension of less than about 1 micron, more typically, less than about 500 nm, and even more typically, less than 300 nm. In one desired embodiment of the present invention, the alumina particles have an average largest particle dimension of from about 50 to about 600 nm, more desirably, from about 70 to about 150 nm. The TEM in FIG. 3 illustrates the lath shape of particles of the present invention as shown by the large width of the particles in comparison to their length.

The alumina particles (both the peptized and unpeptized) of the present invention have a crystalline structure typically with a maximum crystalline dimension of up to about 100 Angstroms as measured using X-ray Diffraction (XRD) techniques, such as using a PANalytical MPD DW3040 PRO Instrument (commercially available from PANalytical B.V. (The Netherlands)) at wavelength equal to 1.54 Angstroms. Crystalline sizes are obtained by using, for example, the Scherrer equation. In one exemplary embodiment of the present invention, the alumina particles of the present invention have a crystalline size of from about 10 to about 50 Angstroms, typically about 30 Angstroms as measured from a 120 XRD reflection, and a crystalline size of from about 30 to about 100 Angstroms, typically about 70 Angstroms as measured from a 020 XRD reflection. The crystalline size ratio of 020 XRD reflection to 120 XRD reflection may range from about 1.1 to about 10.0, and more typically, from about 1.1 to about 3.0.

As a result of the above-described physical properties of the porous metal oxide particles of the present invention, the particles are well suited for use in a variety of liquid and solid products. In one exemplary embodiment of the present invention, peptized alumina particles are used to form a stable dispersion of alumina particles. The dispersion may comprise up to about 40 wt % of the peptized alumina particles of the present invention in water based on a total weight of the dispersion. An acid, such as nitric acid, may be added to the dispersion so as to obtain a dispersion pH of less than about 5.0 (or about 4.5, typically about 4.0, or about 3.5, or about 3.0, or about 2.5, or about 2.0, or about 1.5). The resulting dispersion at 30 wt % solids and a pH of 4.0 desirably has a viscosity of less than about 100 cps, more desirably, less than about 80 cps.

The asymmetrical lath particle shape of the alumina particles of the present invention results in a loosely aggregated system of alumina particles in solution, unlike the tendency of known spherically shaped alumina particles to strongly aggregate with one another. As a result of this loosely aggregated system, a relatively large amount of alumina particles may be present in a given solution while maintaining a relatively low solution viscosity. For example, in one desired embodiment of the present invention, a dispersion containing about 20 wt % of alumina particles based on a total weight of the dispersion at a pH of about 4.0 has a viscosity of less than or about 20 cps. In a further desired embodiment, a dispersion containing about 30 wt % of alumina particles based on a total weight of the dispersion at a pH of about 4.0 has a viscosity of less than or about 80 cps, and a dispersion containing about 40 wt % of alumina particles based on a total weight of the dispersion at a pH of about 4.0 has a viscosity of less than or about 100 cps.

In another embodiment of the present invention, the porous particles comprise silica particles in the form of gels, precipitates, fumed, or the like. Preferably, the particles are precipitated silica particles or silica gel particles made by the process set forth in U.S. Pat. Nos. 5,968,470, 6,171,384, 6,380,265, 6,573,032, 6,780,920 or 6,841,609, the entire subject matter of which is incorporated herein by reference.

In one embodiment of the present invention, the non-porous particles may be metal oxide sols or colloidal dispersions, such as alumina, silica, titania, zirconia, etc., and mixtures thereof. In an exemplary embodiment according to the invention, the non-porous particles may be colloidal silicas, including for example, relatively low alkali cationic colloidal silicas. The colloidal metal oxides may have an average particle size in the range of about 1 to about 300 nanometers and have a solids to alkali metal ratio of at least AW(−0.013SSA+9), AW being the atomic weight of alkali metal present in the colloidal metal oxide and SSA being the specific surface area of the metal oxide, such as those described in U.S. Patent Application Serial No. 20030180478A1, the entire subject matter of which is incorporated herein by reference.

Even though any non-porous metal oxide particles may be utilized in the present invention, the following exemplary embodiment relating to the use of colloidal silica is described in more detail. Most colloidal silica sols contain an alkali. The alkali is usually an alkali metal hydroxide the alkali metals being from Group IA of the Periodic Table (hydroxides of lithium, sodium, potassium, etc.) Most commercially available colloidal silica sols contain sodium hydroxide, which originates, at least partially, from the sodium silicate used to make the colloidal silica, although sodium hydroxide may also be added to stabilize the sol against gelation.

Colloidal silica sols of this exemplary embodiment of the invention have significantly lower levels of alkali metal ions than most commercially available colloidal silica sols. This can be illustrated by calculating the silica solids to sodium weight ratio of the colloidal silica sol using the equation mentioned above. For example, when the alkali metal is sodium, the SiO₂/Alkali Metal ratio is at least the sum of −0.30SSA+207. The silica solids to alkali metal ratios of deionized colloidal silica sols fall within this range and are suitable for this invention. By “deionized,” it is meant that any metal ions, e.g., alkali metal ions such as sodium, have been removed from the colloidal silica solution to an extent such that the colloidal silica has silica solids to alkali metal ratio referred to in the equation mentioned herein. Methods to remove alkali metal ions are well known and include ion exchange with a suitable ion exchange resin (U.S. Pat. Nos. 2,577,484 and 2,577,485), dialysis (U.S. Pat. No. 2,773,028) and electrodialysis (U.S. Pat. No. 3,969,266), the entire subject matter of which is incorporated herein by reference. To impart stability of the colloidal silica sol against gelation, the particles may also be surface modified with aluminum as described in U.S. Pat. No. 2,892,797 (the contents therein incorporated herein by reference), and then the modified silica is deionized. Ludox® TMA silica from W. R. Grace & Co.—Conn having a pH of about 5.0 at 25° C. is an example of commercially available colloidal silica made by this method.

In an exemplary embodiment according to the present invention, the porous metal oxide particles are formed into a dispersion and then the non-porous metal oxide particles are added thereto. Alternatively, the porous metal oxide particles in dry form may be added to the non-porous particles, also in dry form or in the form of a dispersion. The non-porous particles of the present invention may be combined with the porous particle dispersion at a ratio of about 20/1 to about 1/1 (dry basis), preferably about 15/1 to about 1.5/1, more preferably about 12/1 to about 1.8/1, and even more preferably about 10/1 to about 2/1. The combined dispersion may be at a pH of about 2.0 to about 8.0 and possess a viscosity of less than or equal to about 100 cps, preferably less than or equal to about 80 cps, and even more preferably less than or equal to about 60 cps. The dispersion may contain about 10 to about 50 wt % solids content, preferably about 20 to about 40 wt % solids content, and even more preferably about 25 to about 35 wt % solid content based on the weight of the dispersion. In an exemplary embodiment of the present invention, where the porous particles are alumina and the non-porous particles are colloidal silica, the colloidal silica particles are added to an alumina particle dispersion at Al/Si ratio about 9/1 to about 7/3 (dry ratio), at a pH of about 4.0 with a viscosity of less than or equal to about 100 cps, and a solids content of about 20 to about 40 wt %, preferably about 25 to about 35 wt % based upon the total weight of the dispersion.

The above-mentioned high solids content, low viscosity dispersions are particularly useful as coating compositions. The dispersions may be used to coat a surface of a variety of substrates including, but not limited to, a paper substrate, a paper substrate having a polyethylene layer thereon, a paper substrate having an ink-receiving layer thereon, a polymeric film substrate, a metal substrate, a ceramic substrate, and combinations thereof. The resulting coated substrate may be used in a number of applications including, but not limited to, printing applications, catalyst applications, etc.

In another exemplary embodiment, an ink receiving media formulation of the present invention comprises a binder; porous metal oxide particles and non-porous metal oxide particles; wherein an ink receiving layer formed from said formulation possesses an abrasion resistance greater than, and a pore volume equal to or greater than, an ink receiving layer formed without said non-porous particles. The porous particles may be asymmetrical and the non-porous particles may be symmetrical. The particles may be of different chemical compositions and different physical structures. Preferably, the metal oxide particles comprise a first particle that is crystalline and a second particle that is amorphous, such as, for example, a first particle that is boehmitic alumina and a second particle that is colloidal silica. A combined slurry of porous and non-porous particles may be mixed with a water-soluble binder including, for example, diethylaminoethylated starch, trimethylethylammonium, methyl-celluloces, hydroxymethyl celluloses, carboxymethyl celluloses, polyvinyl alcohols, polyethylene glycol, polyvinyl pyrrolidone, polyacylamide and polypropylene glycol, at pigment or particle to binder ratio about 2/1 to about 30/1, preferably about 5/1 to about 20/1, and even more preferably about 8/1 to about 12/1 to make a formulation coating.

In a further exemplary embodiment of the present invention, the particles may be used in a method of making a coated substrate. In one exemplary method, the method of making a coated substrate comprises the steps of providing a substrate having a first surface; and coating an alumina sol onto the first surface of the substrate forming a coating layer thereon. The coating layer may be subsequently dried to form a coated substrate. The coated substrate may be used to form a printed substrate. In one exemplary method of the present invention, a method of forming a printed substrate comprises the steps of applying a color-containing composition onto the coating layer of the coated substrate described above.

Ink jet media may be prepared as mentioned using the ink receiving dispersions or formulations set forth herein and combining them with conventional film formers. In this embodiment, a binder is utilized to provide desirable film properties upon application to a substrate. Any binder may be utilized including all of those set forth herein. However, water-soluble binder is preferred and includes, for example, diethylaminoethylated starch, trimethylethylammonium, methyl-celluloces, hydroxymethyl celluloses, carboxymethyl celluloses, polyvinyl alcohols, polyethylene glycol, polyvinyl pyrrolidone, polyacylamide, polypropylene glycol, and mixtures thereof. Particle to binder ratio about 5/1 to 20/1, preferred about pigment/binder ratio about 8/1 to 12/1 to make a formulation coating. The formulation coating is coated on a resin coated paper substrate then to be dried at 50-100 centigrade for 1-20 minutes, which preferred about 5-10 minutes.

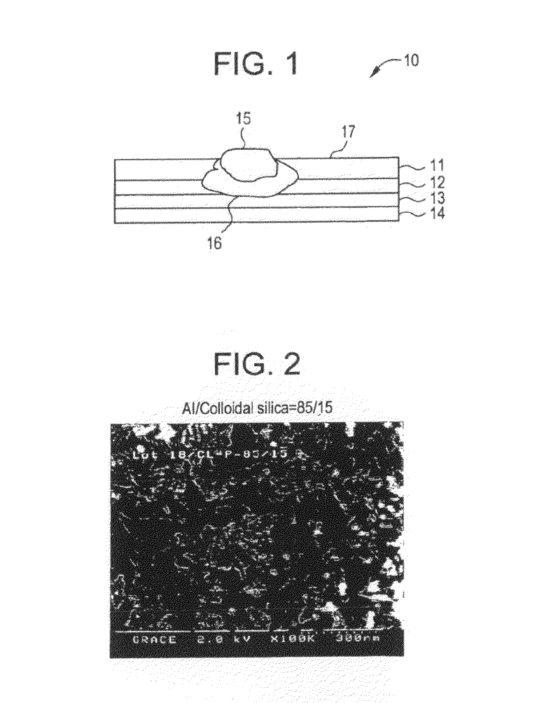

In one exemplary embodiment of the present invention, the coated substrate comprises a printable substrate having a coating layer thereon, wherein the coating layer comprises the mixture of different particles of the present invention. The printable substrate is capable of being used with any printing process, such as an ink jet printing process, wherein a colorant-containing composition (e.g., a dye and/or pigment containing composition) is applied onto an outer surface of the coating layer. In this embodiment, the particles within the coating layer act as wicking agents, absorbing the liquid portion of the colorant-containing composition in a relatively quick manner. An exemplary coated substrate is provided in FIG. 1.

As shown in FIG. 1, exemplary coated substrate 10 comprises coating layer 11, an optional receiving layer 12, an optional support layer 13, and a base layer 14. Coating layer 11 and possibly optional receiving layer 12 comprise the mixture of particles of the present invention. The remaining layers may also comprise such particles of the present invention, although typically optional support layer 13 and base layer 14 do not contain this mixture of particles. Suitable materials for forming optional receiving layer 12 may include, but are not limited to, water absorptive materials such as polyacrylates; vinyl alcohol/acrylamide copolymers; cellulose polymers; starch polymers; isobutylene/maleic anhydride copolymer; vinyl alcohol/acrylic acid copolymer; polyethylene oxide modified products; dimethyl ammonium polydiallylate; and quaternary ammonium polyacrylate, and the like. Suitable materials for forming optional support layer 13 may include, but are not limited to, polyethylene, polypropylene, polyesters, and other polymeric materials. Suitable materials for forming base layer 14 may include, but are not limited to, paper, fabric, polymeric film or foam, glass, metal foil, ceramic bodies, and combinations thereof.

Exemplary coated substrate 10 shown in FIG. 1 also comprises colorant-containing composition 16 shown within portions of coating layer 11, an optional receiving layer 12. FIG. 1 is utilized to illustrate how colorant-containing composition 16, when applied onto surface 17 of coating layer 11, wicks into coating layer 11 and optional receiving layer 12. As shown in FIG. 1, colorant portion 15 of colorant-containing composition 16 remains within an upper portion of coating layer 11, while the liquid portion of colorant-containing composition 16 extends through coating layer 11 and into optional receiving layer 12.

In one exemplary embodiment, abrasion resistant ink receiving media of the present invention comprises a substrate; and an ink receiving layer on the substrate comprising porous metal oxide particles and non-porous metal oxide particles; wherein the ink receiving layer possesses an abrasion resistance greater than, and a pore volume equal to or greater than, an ink receiving layer formed without said non-porous particles. One of the particles may be asymmetrical and the other substantially symmetrical. The particles may be of different chemical compositions and different physical structures. Preferably, the metal oxide particles comprise a first particle that is crystalline and a second particle that is amorphous, such as, for example, a first particle that is boehmitic alumina and a second particle that is colloidal silica. The ink receiving layer may possess an increased abrasion resistance from about 20 to about 90%, preferably from about 30 to about 90%, more preferably from about 40 to about 90%, and even more preferably from about 50 to about 80% compared to abrasion resistance of an ink receiving layer without the non-porous metal oxide particles.

Abrasion resistance of the ink receiving layer is measured by a Taber Type Abrasion Tester available from Yasuda Seiki Seisakusho, LTD using ASTM D4060-07. The ink-receiving layer is subjected to one pass without weight. The abrasion resistance of the ink receiving layer is also measured by a Color Fastness Rubbing Tester available from Yasuda Seiki Seisakusho, LTD using ISO-105-X12 (40 passes with 500 g weight).

Typically, the ink receiving layer of the present invention possesses a Hg porosimeter pore volume of about 0.10 to about 0.50 cc/g, preferably about 0.15 to about 0.45 cc/g, more preferably about 0.20-0.40 cc/g, and even more preferably about 0.25 to about 0.35 cc/g pore volume at coating weight of 30-35 g/m². Hg porosimeter pore volume of the ink receiving layer is measured by mercury intrusion determination by an Autopore 9520 available from Micrometritics Instrument Corp. using ASTM UOP578-02. The addition of the non-porous particles provides increased abrasion resistance, but does not reduce the pore volume of the resulting ink receiving layer. This is unexpected since such non-porous particles do not possess intrinsic porosity, and in addition, one would expect such particles to occupy existing porosity between the porous particles in the ink receptive layer.

In a further exemplary embodiment, abrasion resistant ink receiving media of the present invention comprises a substrate; and an ink receiving layer on the substrate comprising porous alumina particles and non-porous metal oxide particles; wherein the ink receiving layer possesses an abrasion resistance greater than, and a pore volume substantially equal to or greater than, an ink receiving layer formed without said non-porous particles. In an exemplary embodiment, the ink receiving layer possesses Hg porosity (measured using ASTM UOP578-02) of greater than or equal to about 0.25 cc/g pore volume in unit coating weight at 30-35 g/m², which is about 1-10% higher than alumina based ink receiving layers without non-porous particles. The porous alumina particles may be asymmetrical and the non-porous metal oxide particles may be substantially symmetrical. The particles may be of different chemical compositions and different physical structures. As mentioned herein, the abrasion damage to the ink receiving layer is reduced by adding the non-porous particles, and in an exemplary embodiment the non-porous particles may be colloidal silica. The abrasion resistance may be increased about 60 to about 70% by adding colloidal silica at a Al/Si ratio of about 9/1, and preferably the abrasion resistance damage may be increased about 80 to about 90% by adding colloidal silica at a Al/Si of about 8/2 while still maintaining or increasing the pore volume of the ink receiving layer.

It is believed that conventional ink jet media possesses insufficient surface interparticle porosity such that when ink jet ink comprising solvent and pigment particles is printed onto the media, it does not penetrate the surface. This causes the ink pigment particles to build up on the surface of the media forming a filter cake thereon (i.e., multiple layers of pigment particles). As a result, the filter cake may rub off as the media is handled, which yields a printed media that is difficult to read. FIG. 4 illustrates such a conventional printed media 40 with an ink receptive coating 41 and a thick layer 42 of ink pigment particles formed thereon. This layer or filter cake 42 is easily removed from the ink receptive coating with any shear force 43 applied to the media 40. The layer 42 is composed of multiple layers of ink pigment particles, which do not penetrate the ink receptive coating 41.

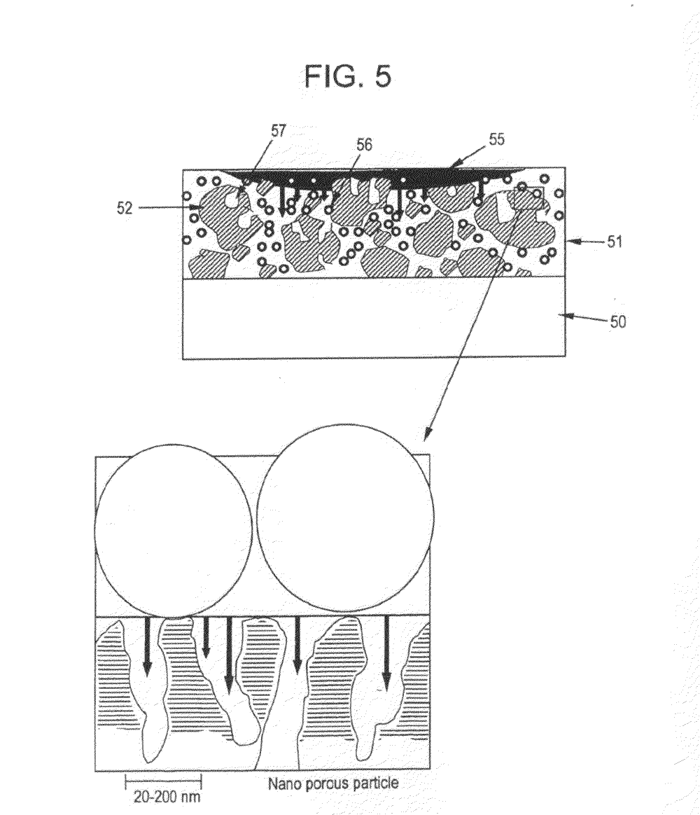

FIG. 5 depicts printed media 50 according to an embodiment of the present invention having an ink receptive coating 51 with porous metal oxide particles 52 and nonporous metal oxide particles 53 therein. A layer of ink 54 is formed on the ink receptive coating 51. Ink pigment particles 55 penetrate into the ink receptive coating 51 via significant inter particle porosity 56. Ink solvent 57 penetrates the pores of the porous metal oxide particles 52, which serves to anchor the ink pigment particles 55 on the surface of the porous metal oxide particles 52. As a result, the ink receptive media of the present invention yields a thin layer of ink pigment bound tightly on the surface of the ink receptive coating and thereby eliminate significant rub off of the ink pigment.

Accordingly, in another exemplary embodiment, the abrasion resistant ink receiving media of the present invention comprises a substrate; an ink receiving layer on the substrate comprising porous metal oxide particles and non-porous metal oxide particles; and a printed pigmented ink layer on the ink receiving layer; wherein the ink receiving layer possesses a rub off resistance greater than an ink receiving layer formed without said non-porous particles.

In a further exemplary embodiment, the abrasion resistant ink receiving media of the present invention comprises a substrate; an ink receiving layer on the substrate comprising porous metal oxide particles and non-porous metal oxide particles; wherein the ink receiving layer possesses an ink adsorption speed greater than an ink receiving layer formed without said non-porous particles.

### EXAMPLES

The present invention is further illustrated by the following examples, which are not to be construed in any way as imposing limitations upon the scope thereof. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### Example 1

11.4 kg of water is added to a vessel, which is then heated to 95° C. Into the water was added 40 wt % nitric acid while stirring until the pH reached 2.0. Sodium aluminate (23 wt % Al₂O₃) is then added at a controlled rate so that the pH of the mixture reached 10.0 in 5 minutes. Once a pH of 10.0 is reached, the addition of sodium aluminate is stopped and the mixture is aged for 1 minute. After aging, 40 wt % nitric acid is added to the reaction vessel at a rate so that the pH of the mixture reached 2.0 in 1 minute. Once a pH of 2.0 is reached, the addition of nitric acid is stopped and the mixture is aged for 3 minutes. At the end of this aging period, sodium aluminate is added again to the reaction vessel in order to increase the pH from 2.0 to 10.0 in 5 minutes.

The above pH cycling steps are repeated for a total of 20 times. At the end of the 20^{th} cycle and while the pH of the mixture is 10.0, the mixture is filtered to recover the formed alumina, and then washed in order to remove any co-produced salts. The filter cake obtained is then spray dried to obtain alumina powder.

The alumina powder formed is dispersed in water to form a mixture, and then the pH of the mixture was adjusting to about 4.0 with nitric acid while stirring. The resulting mixture contained a dispersion of particles having an average particle size of 123 nm as measured using a LA-900 laser scattering particle size distribution analyzer commercially available from Horiba Instruments, Inc. (Irvine, Calif.). The resulting mixture had a viscosity of 80 cps and a solids content of 30 wt % based on a total weight of the mixture.

Drying the mixture at 150° C. resulted in alumina powder having a BET surface area of 172 m²/g and a pore volume of 0.73 cc/g as measured using nitrogen porosimetry.

30 g of the alumina powder are added to 70 g 1% acetic acid solution to make a 30 wt % peptized alumina slurry. Then the peptized alumina slurry is mixed with 25 g of 12% PVA235 solution available from Kuraray Co. Ltd. to prepare a mixture having a 10/1 pigment to binder ratio. This mixture is then added to a 30 g 1 wt % boric acid solution to form a finished ink jet receiving layer coating formulation.

### Example 2

19.25 g the alumina powder from Example 1 are added to 35.75 g 1% acetic acid solution to make a 35 wt % peptized alumina slurry. Then 5.13 g 41.7 wt % Ludox® CL-P colloidal silica available from W. R. Grace & Co.—Conn. is added to the alumina slurry and mixed thoroughly. 17.83 g 12% PVA235 solution is added to this slurry to prepare a mixture having a 10/1 pigment to binder ratio, and then added 21.4 g 1% boric acid solution to form a finished ink jet receiving layer coating formulation.

### Example 3

17.5 g the alumina powder from Example 1 are added to 32.5 g 1% acetic acid solution to make a 35 wt % peptized alumina slurry. Then, 10.49 g 41.7 wt % Ludox® CL-P colloidal silica available from W. R. Grace & Co.—Conn. is added to the alumina slurry and mixed thoroughly. 18.25 g 12% PVA235 solution is added to this slurry to prepare a mixture having a 10/1 pigment to binder ratio, and then added 21.9 g 1% boric acid solution to form a finished ink jet receiving layer coating formulation.

Various substrates were coated using the ink receiving layer formulations of Examples 1-3. Substrates included a paper substrate, a paper substrate having a polyethylene layer thereon, and a paper substrate having a receiving layer thereon (e.g., a coating containing amorphous silica and a water-soluble binder in the form of polyvinyl alcohol). The alumina sol was coated onto each of the substrates using a knife coating process so as to provide a coating layer having a coating weight ranging from about 29 to about 31 g/m². The coated substrates were dried at 80° C. for 20 minutes.

Ink jet receiving layer compositions were applied onto each of the coated substrates. In all cases, the ink compositions quickly penetrated the alumina particle coating. The results set forth in Table 1 indicate that the ink adsorptive speed is very good.

TABLE 1

| | | Gloss | Gloss | Black OD | Ink |
|---|---|---|---|---|---|
| | Coating | unit | unit | (Epson PM | absorptive |
| Example | weight (g) | at 20° | at 60° | 4000PX) | speed |
| 1 | 30 | 13.9 | 36.0 | 1.736 | 5 |
| 2 | 30 | 16.7 | 35.1 | 1.750 | 5 |
| 3 | 30 | 16.3 | 34.7 | 1.780 | 5 |

Note:
Ink absorptive speed. 5 is the best, 1 is the worst.

### Example 4

17.5 g the alumina powder from Example 1 are added to 32.5 g 1% acetic acid solution to make a 35 wt % peptized alumina slurry. Then, 17.99 g 41.7 wt % Ludox® CL-P colloidal silica available from W. R. Grace & Co.—Conn. is added to the alumina slurry and mixed thoroughly. 20.83 g 12% PVA235 solution is added to this slurry to prepare a mixture having a 10/1 pigment to binder ratio, and then added 25 g 1% boric acid solution to form a finished ink jet receiving layer coating formulation.

The formulations of Examples 1-4 are coated onto substrates in the identical process as in Examples 1-3 and tested for abrasion resistance using the test methods set forth herein, which are compared to a commercially available ink jet media, Crispia photo paper available from Epson (Example 5). The results set forth in Table 2 indicate that the damage on the media surface after the abrasion tests is minimized when using the ink jet coating formulations of the present invention.

TABLE 2

| | | | Abrasion test | |
|---|---|---|---|---|
| | Al/ | | Taber | Cyclic |
| | Colloidal | Coating | (without | Swing (500 G, |
| Example | silica | weight (g) | weight) | 20 cycles) |
| 1 | 10/0 | 30 | 1 | 1 |
| 2 | 9/1 | 30 | 4 | 4 |
| 3 | 8/2 | 30 | 5 | 5 |
| 4 | 7/3 | 30 | 5 | 5 |

| | | | |
|---|---|---|---|
| 5 | Commercial silica based glossy | 4 | 5 |
| | media | | |

Note:
5 abrasion damage is lower than 10%
4 abrasion damage is lower than 20%
3 abrasion damage is lower than 30%
2 abrasion damage is lower than 40%
1 abrasion damage is higher than 50%

### Example 5

30 g of 41.7 wt % Ludox® CL-P colloidal silica available from W. R. Grace & Co.—Conn. are mixed with 5 g of 12% OLZ1371 binder solution available from Showa Highpolymer Ltd. to prepare a mixture having a 10/1 pigment to binder ratio. This mixture is then added to a 30 g 1 wt % boric acid solution to form a finished ink jet receiving layer coating formulation.

### Example 6

17.5 g of 40 wt % precipitated silica slurry are added to 17.99 g of 41.7 wt % Ludox® CL-P colloidal silica available from W. R. Grace & Co.-Conn. and mixed thoroughly. 20.83 g 12% OLZ1371 binder solution available from Showa Highpolymer Ltd. is added to this slurry to prepare a mixture having a 10/1 pigment to binder ratio, and then added 25 g 1% boric acid solution to form a finished ink jet receiving layer coating formulation.

### Example 7

17.5 g the alumina powder from Example 1 are added to 32.5 g 1% acetic acid solution to make a 35 wt % peptized alumina slurry. Then, 17.99 g 41.7 wt % Ludox® CL-P colloidal silica available from W. R. Grace & Co.—Conn. is added to the alumina slurry and mixed thoroughly. 20.83 g 12% OLZ1371 binder solution available from Showa Highpolymer Ltd. is added to this slurry to prepare a mixture having a 10/1 pigment to binder ratio, and then added 25 g 1% boric acid solution to form a finished ink jet receiving layer coating formulation.

### Example 8

30 g of 41.7 wt % Ludox® AS40 colloidal silica available from W. R. Grace & Co.—Conn. are mixed with 5 g of 12% PVA217 binder solution available from Kuraray Co. Ltd. to prepare a mixture having a 10/1 pigment to binder ratio. This mixture is then added to a 30 g 1 wt % boric acid solution to form a finished ink jet receiving layer coating formulation.

### Example 9

17.5 g of 40 wt % precipitated silica slurry are added to 1.8 g of 41.7 wt % Ludox® AS40 colloidal silica available from W. R. Grace & Co.—Conn. is added to the alumina slurry and mixed thoroughly. 20.83 g 12% OLZ1371 binder solution available from Showa Highpolymer Ltd. is added to this slurry to prepare a mixture having a 10/1 pigment to binder ratio, and then added 25 g 1% boric acid solution to form a finished ink jet receiving layer coating formulation.

The formulations of Examples 5-9 are coated onto substrates in the identical process as in Examples 1-3. The substrates are prepared by forming a base coating thereon. The base coating is formulated by mixing 100 parts of micronized silica gel, SYLOJET® P508 silica gel available from W. R. Grace & Co.—Conn., with 4 parts of PVOH polymer PVA-117 available from Kuraray Co. Ltd., 22 parts of polyvinyl acetate latex AM-3150 available from Showa Highpolymer Ltd., and 10 parts cationic polymer CP-103 available from Senka Co. The base coating mixture is then formed on the substrate by in the same manner as Examples 1-3. Subsequently, the ink receptive coating is formed thereon and tested for print quality. Pigmented ink is printed on the ink jet receiving layers and ink adsorption is measured. The results set forth in Table 3 indicate that the ink adsorptive speed is very good for ink jet receptive coating formulations of the present invention (Examples 6, 7 and 9).

| | | | Example | | | | |
|---|---|---|---|---|---|---|---|
| | | | 5 | 6 | 7 | 8 | 9 |
| Absorptive Coat | | | P508/CP103/PVA117/AM3150 = 100/10/10/4/22 | | | | |
| Topcoat | Grace | LUDOX ® CL-P | 100 | 50 | 50 | | |
| | nanoparticle and/ | Silica Slurry B | | 50 | | | |
| | or nanoporous | Alumina slurry | | | 50 | | |
| | pigment | LUDOX ® AS40 | | | | 100 | 90 |
| | | Silica Slurry A | | | | | 10 |
| | Binder | PVA217 | | | | 5 | 5 |
| | | OLZ1371 | 4 | 4 | 4 | | |
| | Epson | BK | 1.59 | 1.62 | 1.74 | 2.08 | 2.02 |
| | PM4000PX | C | 0.62 | 0.67 | 0.63 | 0.66 | 0.65 |
| | (Gloss Paper) | M | 1.06 | 1.10 | 1.03 | 1.18 | 1.16 |
| | | Y | 0.79 | 0.78 | 0.75 | 0.79 | 0.79 |

| | | | | | |
|---|---|---|---|---|---|
| Ink Absorption | Poor | Good | Good | Poor | Good |

While the invention has been described with a limited number of embodiments, these specific embodiments are not intended to limit the scope of the invention as otherwise described and claimed herein. It may be evident to those of ordinary skill in the art upon review of the exemplary embodiments herein that further modifications, equivalents, and variations are possible. All parts and percentages in the examples, as well as in the remainder of the specification, are by weight unless otherwise specified. Further, any range of numbers recited in the specification or claims, such as that representing a particular set of properties, units of measure, conditions, physical states or percentages, is intended to literally incorporate expressly herein by reference or otherwise, any number falling within such range, including any subset of numbers within any range so recited. For example, whenever a numerical range with a lower limit, R_{L}, and an upper limit R_{U}, is disclosed, any number R falling within the range is specifically disclosed. In particular, the following numbers R within the range are specifically disclosed: R═R_{L}+k(R_{U}−R_{L}), where k is a variable ranging from 1% to 100% with a 1% increment, e.g., k is 1%, 2%, 3%, 4%, 5%. . . . 50%, 51%, 52%. . . . 95%, 96%, 97%, 98%, 99%, or 100%. Moreover, any numerical range represented by any two values of R, as calculated above is also specifically disclosed. Any modifications of the invention, in addition to those shown and described herein, will become apparent to those skilled in the art from the foregoing description and accompanying drawings. Such modifications are intended to fall within the scope of the appended claims. All publications cited herein are incorporated by reference in their entirety.

What is claimed is:

1. Abrasion resistant ink receiving media comprising:
(a) a substrate; and
(b) an ink receiving layer on the substrate comprising porous metal oxide particles and non-porous metal oxide particles;
wherein the ink receiving layer possesses an abrasion resistance greater than, and a pore volume substantially equal to or greater than, an ink receiving layer formed without said non-porous particles.

2. An ink receiving media according to claim 1, wherein said abrasion resistance is greater than or equal to about 20 to about 90% of the abrasion resistance of an ink receiving layer formed without said non-porous particles.

3. An ink receiving media according to claim 1, wherein said ink receiving layer possesses a pore volume equal to or greater than 5% of the pore volume of an ink receiving layer formed without said non-porous particles.

4. An ink receiving media according to claim 1, wherein said ink receiving layer possesses a pore volume of greater than or equal to about 0.10 to about 0.50 cc/g based on a coating weight of 30-35 g/m².

5. (canceled)

6. (canceled)

7. An ink receiving media according to claim 1, wherein said porous metal oxide particles comprise boehmitic alumina and said non-porous particles comprise colloidal silica.

8. An ink receiving media according to claim 7, wherein said porous particles comprise an aspect ratio of at least about 1.2.

9. An ink receiving media according to claim 1, wherein said porous metal oxide particles comprise precipitated silica and said non-porous particles comprise colloidal silica.

10. Abrasion resistant ink receiving media comprising:
(a) a substrate; and
(b) an ink receiving layer on the substrate comprising porous alumina particles and non-porous metal oxide particles;
wherein the ink receiving layer possesses an abrasion resistance greater than, and a pore volume substantially equal to or greater than, an ink receiving layer formed without said non-porous particles.

11. An ink receiving media according to claim 10, wherein said abrasion resistance is greater than or equal to about 20 to about 90% of the abrasion resistance of an ink receiving layer formed without said non-porous particles.

12. An ink receiving media according to claim 10, An ink receiving media according to claim 1, wherein said ink receiving layer possesses a pore volume equal to or greater than 5% of the pore volume of an ink receiving layer formed without said non-porous particles.

13. An ink receiving media according to claim 10, wherein said ink receiving layer possesses a pore volume of greater than or equal to about 0.10 to about 0.50 cc/g based on a coating weight of 30-35 g/m².

14. (canceled)

15. (canceled)

16. An ink receiving media according to claim 10, wherein said porous alumina particles comprise boehmitic alumina and said non-porous particles comprise colloidal silica.

17. An ink receiving media according to claim 10, wherein said alumina particles comprise an aspect ratio of at least about 1.2.

18. An ink receiving media formulation comprising:
(a) a binder; and
(b) porous metal oxide particles and non-porous metal oxide particles; wherein an ink receiving layer formed from said formulation possesses an abrasion resistance greater than, and a pore volume substantially equal to or greater than, an ink receiving layer formed without said non-porous particles.

19. (canceled)

20. An ink receiving media formulation according to claim 18, wherein said porous particles comprise boehmitic alumina and said non-porous particles comprise colloidal silica.

21. An ink receiving media formulation according to claim 18, wherein said porous particles comprise an aspect ratio of at least about 1.2.

22. An ink receiving media formulation according to claim 18, wherein said porous metal oxide particles comprise precipitated silica and said non-porous particles comprise colloidal silica.

23. An ink receiving media dispersion comprising:
(a) a solvent; and
(b) porous metal oxide particles and non-porous metal oxide particles; wherein an ink receiving layer formed from said dispersion possesses an abrasion resistance greater than, and a pore volume substantially equal to or greater than, an ink receiving layer formed without said non-porous particles.

24. (canceled)

25. An ink receiving media dispersion according to claim 23, wherein said porous particles comprise boehmitic alumina and said non-porous particles comprise colloidal silica.

26. An ink receiving media dispersion according to claim 23, wherein said porous particles comprise an aspect ratio of at least about 1.2.

27. An ink receiving media dispersion according to claim 23, wherein said porous metal oxide particles comprise precipitated silica and said non-porous particles comprise colloidal silica.

28. (canceled)

29. (canceled)
